(19) United States
(12) Patent Application Publication
(10) Pub. No.: US 2008/0211318 A1
(43) Pub. Date: Sep. 4, 2008

(54) SWITCH CIRCUIT

(75) Inventor: Chia-Wei Wang, Taipei City (TW)

Correspondence Address: J C PATENTS, INC., 4 VENTURE, SUITE 250, IRVINE, CA, 92618, US

(73) Assignee: BEYOND INNOVATION TECHNOLOGY CO., LTD., Taipei City (TW)

(21) Appl. No.: 11/970,917

(22) Filed: Jan. 8, 2008

(30) Foreign Application Priority Data
Mar. 2, 2007 (TW) 96107140

(51) Int. Cl. H01H 47/00

(52) U.S. Cl. 307/130

(57) ABSTRACT

A switch circuit including a control unit and a voltage level adjusting circuit is provided. The control unit has a first end, a second end, and a third end. The first end of the control unit receives a first voltage, and the voltage difference between the first end and the third end is steady. In addition, the voltage level adjusting circuit has a switch which is determined whether or not turning on according to the voltage on the second end of the control unit, so as to determine whether driving a load or not. The voltage level adjusting circuit is used for adjusting a bias of the load on driving. The switch has a source. The voltage on the source is varied following the ON/OFF of the switch, and the voltage on the third end of the control unit is varied following the voltage on the source.

### CROSS-REFERENCE TO RELATED APPLICATION

This application claims the priority benefit of Taiwan application serial no. 96107140, filed on Mar. 2, 2007. The entirety of the above-mentioned patent application is hereby incorporated by reference herein and made a part of this specification.

### BACKGROUND OF THE INVENTION

1. Field of the Invention

The present invention relates to a switch circuit. More particularly, the present invention relates to a switch circuit for reducing circuit area.

2. Description of Related Art

FIG. 1a is a circuit diagram of a conventional switch circuit. Referring to FIG. 1a, the early switch circuit 100 used to drive an LED 130 only includes a power source 160, a voltage regulator module 120, a control unit 142, and a buck unit 110.

The conventional control unit 142 attempts to have its output end OUT coupled to an NMOS transistor 152 in the buck unit 110, so as to control the ON/OFF of the NMOS transistor 152. The ON/OFF of the NMOS transistor 152 further controls whether or not to lighten the LED 130. Generally speaking, the NMOS transistor 152 has a first source/drain end coupled to the power source 160, a second source/drain end connected to a ground terminal GND, and a gate end coupled to an output end OUT of the control unit 142.

In practice, when the NMOS transistor 152 is not turned on, an inductor 111 and the LED 130 form a current loop, and the LED 130 is lightened, merely through the energy storage of the inductor 111 and the capacitor 112 in the buck unit 110.

To turn on the NMOS transistor 152, preferably, as the drain of the NMOS transistor 152 is coupled to the power source 160, the voltage level of the source of the NMOS transistor 152 equals that of the power source 160. The output end OUT of the control unit 142 can only provide at most a voltage Vi equivalent to the power source 160 to the gate of the NMOS transistor 152. Thus, as the gate and the source of the NMOS transistor 152 are at the same voltage level, the NMOS transistor 152 cannot be turned on, and the LED 130 cannot be lightened, which is referred to as an error operation.

To solve the above error operation, in the conventional art, a boot-strap circuit is further provided between the control unit 142 and the buck unit 110. FIG. 1b is a circuit diagram of another conventional switch circuit. Referring to FIG. 1b, when the control unit 142 outputs a control signal to turn on an NMOS transistor 144 in the boot-strap circuit 140, the voltage level of a node N1 is eventually dropped to the ground level (a negative end of the power source Vi may be regarded as the ground), and BJT transistors 146, 148 in the boot-strap circuit 140 are turned off. At this time, no current passes through the gate end of the NMOS transistor 152, i.e., the NMOS transistor 152 is also turned off.

When the control unit 142 outputs a control signal to turn off the MOS transistor 144, the base ends of the BJT transistors 146, 148 are at a high voltage level, and the BJT transistor 146 is turned on, while the BJT transistor 148 is not turned on. At this time, the energy storage of a capacitor 149 in the boot-strap circuit 140 keeps the gate end of the NMOS transistor 152 at a double Vi level at most, and turns on the NMOS transistor 152. Thus, the switch circuit 100 successfully turns on the NMOS transistor 152 through the boot-strap circuit 140. That is to say, the switch circuit 100 can successfully generate a driving current I₁ to lighten the LED 130.

However, if the error operation of the switch circuit 100 can be solved with a simpler design, such design can surely save the cost of the switch circuit 100 and make the switch circuit 100 bring about more economic benefits. Therefore, the present invention provides a switch circuit having a simple design and solving the problem of error operation.

### SUMMARY OF THE INVENTION

Accordingly, the present invention is directed to provide a switch circuit for reducing the circuit area.

A switch circuit including a control unit and a voltage level adjusting circuit is provided. The control unit has a first end, a second end, and a third end. In an embodiment of the present invention, the first end of the control unit receives a first voltage, and the voltage difference between the first end and the third end is steady. In addition, the voltage level adjusting circuit has a switch. Whether the switch can be turning on or off depends on a voltage on the second end of the control unit, so as to drive a load furthermore the voltage level adjusting circuit is used for adjusting the bias of the load on driving. The switch has a source. The voltage on the source is varied following the ON/OFF of the switch, and the voltage on the third end of the control unit is varied following the voltage on the source of the switch.

In order to make the aforementioned and other objectives, features, and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1a and 1b are circuit diagrams of conventional switch circuits.

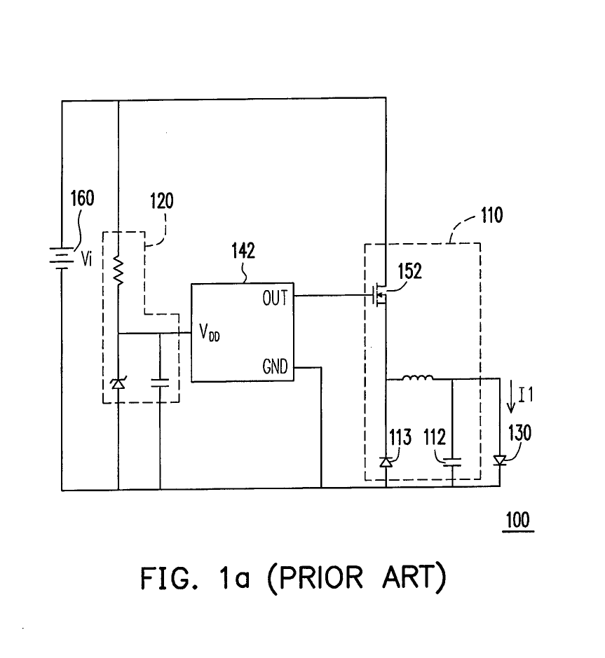

FIG. 2 is a circuit diagram of a switch circuit according to an embodiment of the present invention.

FIG. 3 is a timing chart of the control unit outputting a voltage according to the present invention.

FIG. 4 is a circuit diagram of a control unit according to an embodiment of the present invention.

FIG. 5 is a circuit diagram of another control unit according to the present invention.

FIG. 6 is a circuit diagram of another switch circuit according to the present invention.

### DESCRIPTION OF EMBODIMENTS

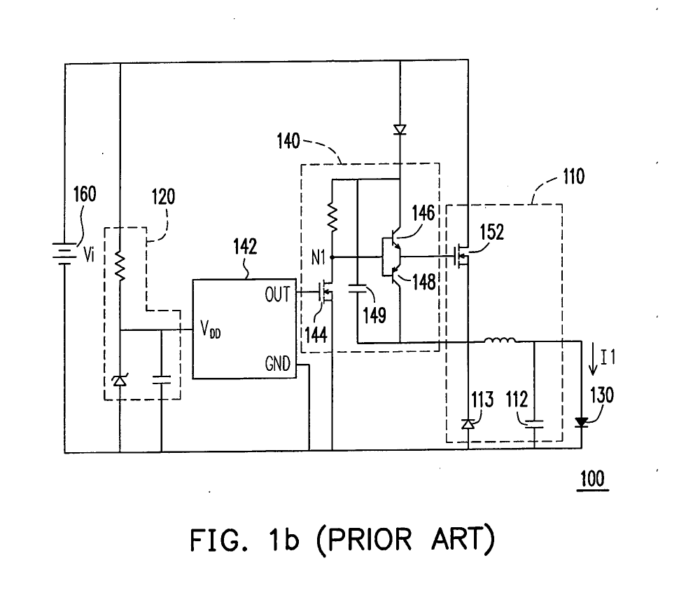

FIG. 2 is a circuit diagram of a switch circuit according to an embodiment of the present invention. Referring to FIG. 2, the switch circuit 200 includes a control unit 213 and a voltage level adjusting circuit 220. The control unit 213 controls the voltage level adjusting circuit 220 to generate a driving current I to drive a load 243. In this embodiment, the control unit 213 is a pulse width modulation (PWM) control unit having an output end OUT, a ground terminal GND, a positive feedback input end FB⁺, a negative feedback input end FB⁻, and a voltage input end V_{DD}. The control unit 213 outputs a control signal to determine whether or not to turn on a switch 215 in the voltage level adjusting circuit 220.

In this embodiment, the switch 215 may be realized by an NMOS transistor 217. A drain end of the NMOS transistor 217 receives a bias Vi provided by a power source 260, and a gate end of the NMOS transistor 217 is coupled to an output end OUT of the control unit 213. In particular, a source end of the NMOS transistor 217 is coupled to the ground terminal GND of the control unit 213. The details will be given in the following few paragraphs.

In this embodiment, the voltage level adjusting circuit 220 includes an inductor 223, a diode 225, a capacitor 227, and the switch 215. A first end of the inductor 223 is coupled to the source end of the NMOS transistor 217 and a cathode end of the diode 225, and an anode end of the diode 225 is coupled to a negative end of the power source 260. The capacitor 227 is coupled between a second end of the inductor 223 and the negative end of the power source 260. In addition, the second end of the inductor 223 is also coupled to the load 243, so as to output a signal for driving the load 243.

In this embodiment, the load 243 is an LED 247. An anode end of the LED 247 is coupled to the voltage level adjusting circuit 220, and a cathode end of the LED 247 is coupled to the control unit 213 through a feedback circuit 240. The feedback circuit 240 includes a resistor 245. The control unit 213 acquires the magnitude of the driving current I through the voltage on two ends of the resistor 245 (i.e., the voltages on the positive feedback input end FB⁺ and negative feedback input end FB⁻ of the control unit 213), so as to regulate the signal output by the output end OUT according to the magnitude of the driving current I.

When the output end OUT of the control unit 213 outputs a low voltage level signal to a gate of the NMOS transistor 217, as the voltage on the drain of the NMOS transistor 217 is Vi, and preferably the voltage on the drain of the NMOS transistor 217 equals the voltage on the source, the voltage on the gate of the NMOS transistor 217 is smaller than the voltage on the source. That is, the voltage difference between the gate and the source of the NMOS transistor 217 is smaller than a threshold voltage, and the NMOS transistor 217 is in the OFF state. At this time, through the energy storage of the inductor 223 and the capacitor 227, the inductor 223, the LED 247, and the resistor 245 form a current loop, and the LED 230 is lightened.

As the voltage level of the negative end of the power source 260 is the lowest voltage level (assumed to be the ground level) of the overall switch circuit, and the ground terminal GND of the control unit 213 is coupled to the negative end of the power source 260 through the inductor 223 and the capacitor 227, the difference between the voltage levels of the ground terminal GND of the control unit 213 and the negative end of the power source 260 is the storage level of the inductor 223 and the capacitor 227.

The voltage difference between the ground terminal GND and the voltage input end V_{DD} of the control unit 213 is steady, so the voltage on the input end V_{DD} of the control unit 213 is varied following the voltage on the ground terminal GND. In other words, if the energy storage level of the inductor 223 and the capacitor 227 reaches the level of voltage Vi, the voltage level of the voltage input end V_{DD} of the control unit 213 reaches the voltage level of V_{DD}+Vi, i.e., the output end OUT of the control unit 213 outputs the voltage level of V_{DD}+Vi.

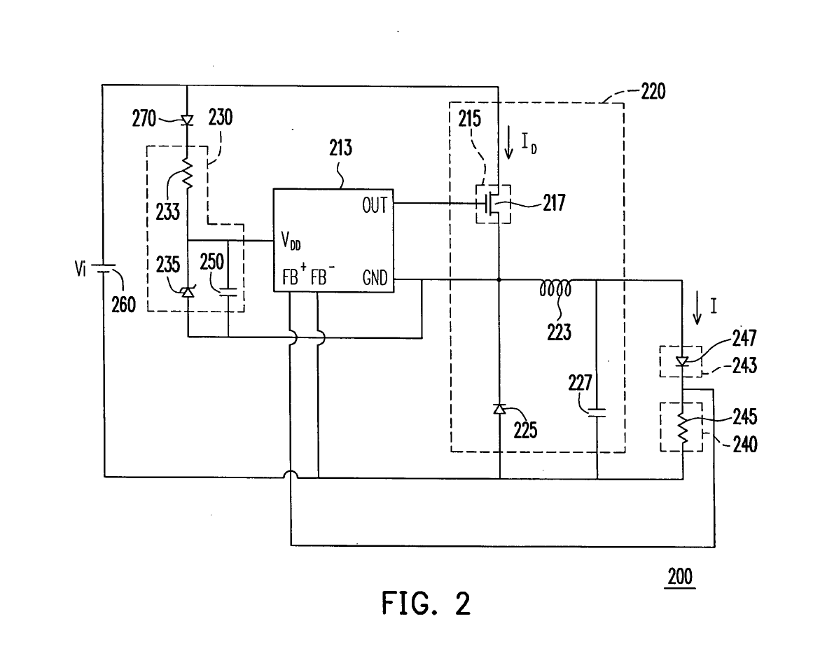

Referring to FIG. 3, FIG. 3 is a timing chart of the control unit outputting a voltage according to the present invention. In this embodiment, the output of the control unit 213 is a PWM signal, for example, as shown in FIG. 3(a). The voltage level of the PWM signal is from the voltage level of the voltage input end V_{DD} to the voltage level of the ground terminal GND of the control unit 213. In this embodiment, when the transistor 217 is turned on, a bias Vi is added onto the voltage on the ground terminal GND of the control unit 213, such that the voltage level of the PWM signal entirely rises by a bias Vi, for example, as shown in FIG. 3(b). Therefore, in this embodiment, when the transistor 217 is turned on, the voltage difference between the gate end and the second source/drain end of the transistor 217 is larger than the threshold voltage, such that the transistor 217 may not cause an error operation.

Therefore, when the output end OUT of the control unit 213 outputs a high voltage level signal of V_{DD}+Vi, the voltage (V_{DD}+Vi) on the gate end of the NMOS transistor 217 is larger than the voltage (Vi) on the source end. That is, the voltage difference between the gate and the source of the NMOS transistor 217 is larger than the threshold voltage, and the NMOS transistor 217 is turned on. When the NMOS transistor 217 is in the ON state, a current ID passes through the NMOS transistor 217 to the inductor 223 and the capacitor 227, such that the inductor 223 and the capacitor 227 start storing energy. The difference between the voltage levels of the two ends of the capacitor 227 makes the driving current I pass through the LED 247, so as to lighten the LED 247. At this time, as the NMOS transistor 217 is successfully turned on and the LED 130 is successfully lightened, the switch circuit 200 may not cause the error operation.

In addition, the switch circuit 200 further includes a voltage regulator module 230. The voltage regulator module 230 includes a resistor 233, a zener diode 235, and a capacitor 250. One end of the resistor 233 receives the bias Vi, and the other end is coupled to the voltage input end V_{DD} of the control unit 213. Besides, the zener diode 235 is connected in parallel with the capacitor 250.

When the bias Vi passes through the resistor 233 to the voltage input end V_{DD} of the control unit 213, after subtracting the voltage drop on the resistor 233 from the bias Vi, the voltage on the node of the resistor 233 and the zener diode 235 is smaller than the zener voltage Vz, and the zener diode 235 remains in normal operation. On the contrary, after subtracting the voltage drop of the resistor 233 from the bias Vi, the voltage on the node of the resistor 233 and the zener diode 235 is larger than the zener voltage Vz, the zener diode 235 maintains the voltage difference between the voltage input end V_{DD} and the ground terminal GND of the control unit 213 at the zener voltage Vz.

The diode 270 has the following functions. Normally, when the diode 270 is turned on, the power source can provide a steady voltage for the voltage input end V_{DD} of the control unit 213 through the voltage regulator module 230. When the voltage level of the voltage input end V_{DD} of the control unit 213 moves with the voltage level of the ground terminal GND, i.e., the voltage level of the voltage input end V_{DD} of the control unit 213 may be larger than the voltage level Vi provided by the power source 260, the diode 270 is turned off, so as to avoid the conflict between the steady voltage level Vi of the power source 260 and the voltage level of the voltage input end V_{DD} of the control unit 213.

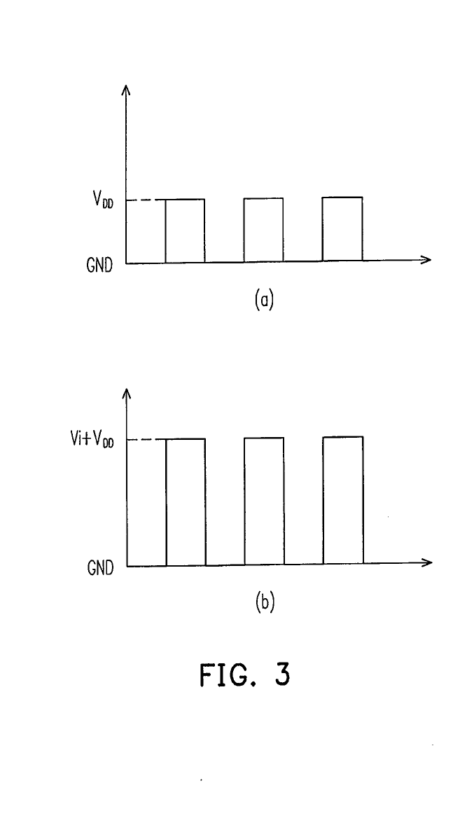

FIG. 4 is a circuit diagram of a control unit according to an embodiment of the present invention, which may function as the control unit 213 in FIG. 2. Referring to FIG. 4, the control unit 213 includes an adder 410, a feedback comparator 413, a changeover switch 415, an output comparator 417, a capacitor 420, and an inverter 422. An input end of the adder 410 is the negative feedback input end FB⁻ of the control unit 213, and the other end of the adder 410 is used to receive a reference voltage V_{ref} and output an operation signal. A positive input end of the feedback comparator 413 is the positive feedback input end FB⁺ of the control unit 213, and a negative input end of the feedback comparator 413 is used to receive the operation signal output by the receives adder 410. The feedback comparator 413 generates a comparison signal.

A positive input end of the output comparator 417 is used to receive an oscillation signal Vo, and an output end of the output comparator 417 is the output end OUT of the control unit 213. The changeover switch 415 is disposed between an output end of the feedback comparison circuit 413 and the output comparator 417, and the capacitor 420 is coupled between a negative input end of the output comparator 417 and a ground terminal G. Moreover, the inverter 422 is coupled between an output end of the output comparator 417 and the changeover switch 415.

Referring to FIGS. 2 and 4 together, when the transistor 217 is turned on, the voltage on the node of the second source/drain end of the transistor and the inductor 223 is the bias Vi. At this time, the feedback voltage on the positive feedback input end FB⁺ of the control unit 213 is the voltage generated on the resistor 245 by the driving current I. As the voltage level of the ground terminal GND of the control unit 213 is varied following the ON/OFF of the transistor 217, the present invention provides the following operations.

When the bias Vi is larger than the feedback voltage on the positive feedback input end FB⁺ of the control unit 213, the conventional control unit cannot process the feedback signal. Thus, in FIG. 4, when the voltage level of the output end of the output comparator 417 is a high voltage level, the inverter 422 outputs a low voltage level to the changeover switch 415. Then, the changeover switch 415 is turned off depends on the low voltage level, such that the voltage output by the output end OUT of the control unit 400 will not be influenced by the feedback signal.

When the transistor 217 is turned off, according to the above description, the ground terminal GND of the control unit 213 is at a low voltage level. At this time, the feedback voltage received by the positive feedback input end FB⁺ of the control unit 213 is a voltage generated by the driving current I on the resistor 245.

In FIG. 4, the adder 410 outputs an operation signal V_{ref}+FB⁻, which is transmitted to the negative input end of the feedback comparator 413. The feedback comparator 413 outputs a comparison signal according to the voltage levels of the positive input end and the negative input end, so as to determine the duty cycle of the NMOS transistor 217 in FIG. 2, and meanwhile to determine the magnitude of the driving current I passing through the LED 247. When the voltage level of the positive input end of the feedback comparator 413 is larger than that of the negative input end (FB⁺>V_{ref}+FB⁻), it indicates that the driving current I is extremely large, and the feedback comparator 413 outputs a comparison signal to turn on the switch 415, such that the capacitor 420 is made to store energy and the voltage level of the negative input end of the feedback comparator 413 is raised. As the oscillation signal Vo received by the positive input end of the feedback comparator 413 is a triangular wave signal, when the voltage level of the negative input end of the feedback comparator 413 is raised, the time interval during which the triangular wave level is larger than the voltage level of the negative input end of the feedback comparator 413 is reduced, such that the duty cycle of the NMOS transistor 217 is shortened, and the driving current I becomes smaller eventually.

On the contrary, when the voltage level of the positive input end of the feedback comparator 413 is smaller than that of the negative input end (FB⁺<V_{ref}+FB⁻), it indicates that the driving current I is too small, the feedback comparator 413 outputs another comparison signal to turn off the switch 415, such that the energy stored by the capacitor 420 is conducted to the ground terminal G and the voltage level of the capacitor 420 is dropped. Similarly, as the oscillation signal Vo received by the positive input end of the feedback comparator 413 is a triangular wave signal, when the voltage level of the negative input end of the feedback comparator 413 is dropped, the time interval during which the triangular wave level is larger than the voltage level of the negative input end of the feedback comparator 413 is extended, such that the duty cycle of the NMOS transistor 217 is prolonged, and the driving current I becomes larger eventually.

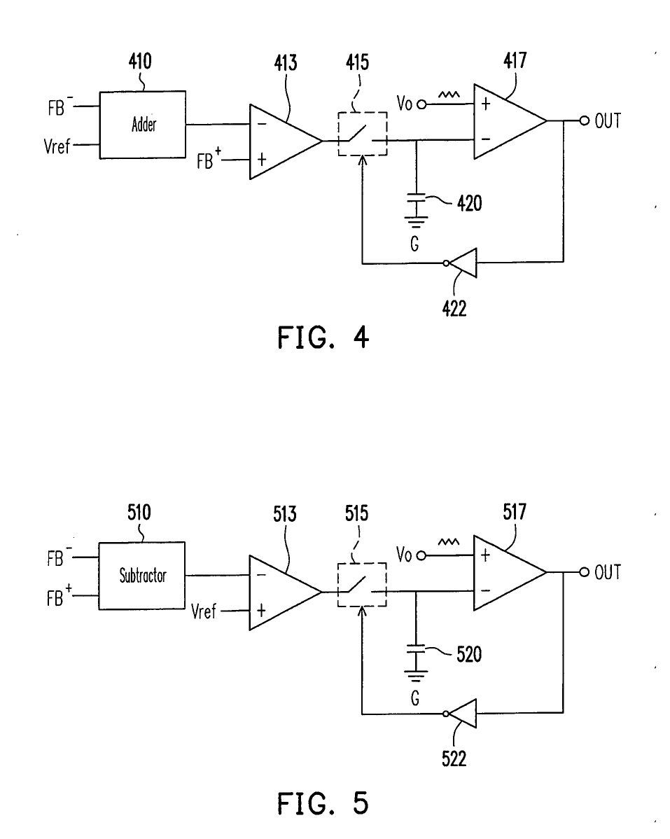

FIG. 5 is a circuit diagram of another control unit according to the present invention, which may function as the control unit in FIG. 2. Referring to FIG. 5, the control unit 213 in FIG. 5 includes a subtractor 510, a feedback comparator 513, a changeover switch 515, an output comparator 517, a capacitor 520, and an inverter 522.

Referring to FIGS. 4 and 5 together, the coupling relationship and the element function of the changeover switch 515 can refer to the changeover switch 415. The coupling relationship and element function of the output comparator 517 can refer to the output comparator 417. The coupling relationship and element function of the capacitor 520 can refer to the capacitor 420. The coupling relationship and element function of the inverter 522 can refer to the inverter 422.

The major difference between the control unit in FIG. 5 and the control unit in FIG. 4 is that, the two input ends of the subtractor 510 of this embodiment are respectively the negative feedback input end FB⁻ and the positive feedback input end FB⁺ of the control unit. The subtractor 510 outputs an operation signal to the negative input end of the feedback comparator 513. The positive input end of the feedback comparator 513 receives a reference voltage V_{ref}. The feedback comparator 513 outputs a comparison signal to the changeover switch 515.

Referring to FIGS. 2 and 5 together, when the bias Vi is larger than the feedback voltage on the positive feedback input end of the control unit 213, the control unit 213 cannot process the feedback signal. Thus, when the voltage level of the output end of the output comparator 517 is the high voltage level, the inverter 522 outputs a low voltage level to the changeover switch 515. Then, the changeover switch 515 is turned on depends on the low voltage level, such that the voltage output by the output end OUT of the control unit 213 may not be influenced by the feedback signal.

When the transistor 217 is turned off, according to the above description, the ground terminal of the control unit 213 is at the low voltage level. At this time, the feedback voltage received by the positive feedback input end FB⁺ of the control unit 213 is the voltage generated on the resistor 245 by the driving current I.

The subtractor 510 outputs an operation signal FB⁺−FB⁻, which is transmitted to the negative input end of the feedback comparator 513. The feedback comparator 513 outputs a comparison signal according to the voltage levels of the positive input end and the negative input end. When the voltage level of the positive input end of the feedback comparator 513 is larger than that of the negative input end (V_{ref}>FB⁺−FB⁻), it indicates that the driving current I is too small, and the feedback comparator 513 outputs a comparison signal to turn off the switch 515, such that the voltage level of the capacitor 520 is dropped. Similarly, as the oscillation signal Vo received by the positive input end of the feedback comparator 513 is a triangular wave signal, when the voltage level of the negative input end of the feedback comparator 513 is dropped, the time interval during which the triangular wave level is larger than the voltage level of the negative input end of the feedback comparator 513 is extended, such that the duty cycle of the NMOS transistor 217 is prolonged, and the driving current I becomes larger eventually.

On the contrary, when the voltage level of the positive input end of the feedback comparator 513 is smaller than that of the negative input end (V_{ref}<FB⁺−FB⁻), it indicates that the driving current I is extremely large, the feedback comparator 513 outputs a comparison signal to turn on the switch 515, such that the voltage level of the capacitor 520 is raised. Similarly, as the oscillation signal Vo received by the positive input end of the feedback comparator 513 is a triangular wave signal, when the voltage level of the negative input end of the feedback comparator 513 is raised, the time interval during which the triangular wave level is larger than the voltage level of the negative input end of the feedback comparator 513 is reduced, such that the duty cycle of the NMOS transistor 217 is shortened, and the driving current I becomes smaller eventually.

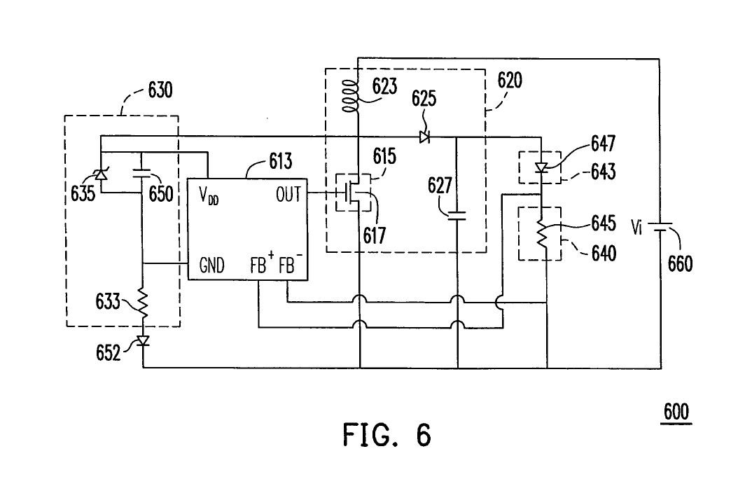

FIG. 6 is a circuit diagram of another switch circuit according to the present invention. Referring to FIG. 6, the switch circuit 600 of this embodiment includes a voltage level adjusting circuit 620, a voltage regulator module 630, and a feedback circuit 640.

The difference between this embodiment and that of FIG. 2 is described as follows. In this embodiment, the voltage level adjusting circuit 620 is a boost circuit, and a switch 615 of the voltage level adjusting circuit 620 is a PMOS transistor 617. The boost circuit 620 includes an inductor 623, a diode 625, a capacitor 627, and a PMOS transistor 617. The inductor 623 is disposed between a power source 660 and a source end of the PMOS transistor 617. An anode end of the diode 625 is coupled to a node where the inductor and the source end of the PMOS transistor 617 are coupled, and a cathode end of the diode 625 is coupled to an end of the capacitor 627 and then is coupled to the ground terminal GND through the other end of the capacitor 627.

Whenever the switch circuit 600 operates, the inductor 623 starts storing energy. The voltage level of the source end of the PMOS transistor coupled to an end of the inductor 623 and the voltage level of the voltage input end V_{DD} of the control unit 613 are varied following the amount of the energy stored in the inductor 623.

As the voltage level of the voltage input end V_{DD} of the control unit 613 equals the voltage level of the source end of the PMOS transistor 617, the output end OUT of the control unit 613 can provide a voltage equal to or smaller than the voltage level of the source end of the PMOS transistor 617 to a gate of the PMOS transistor 617. Thus, the control unit 613 controls the ON/OFF of the PMOS transistor 617.

When the PMOS transistor 617 is turned off, at this time, the diode 625 is turned on, such that the inductor 623 charges the capacitor 627, and the load (not shown) between the two ends of the capacitor 627 can be driven. When the PMOS transistor 617 is turned on, the capacitor 627, an LED 647, and a resistor 645 form a current loop, and the LED 643 is lightened.

The switch circuit 600 also includes a voltage regulator circuit 630. The voltage regulator circuit 630 includes a capacitor 650, a zener diode 635, and a resistor 633. Moreover, the switch circuit 600 also includes a diode 652 to prevent the conflict between voltage levels.

In view of the above, as the voltage level adjusting circuit of the switch circuit of the present invention is coupled to the ground terminal of the control unit, the switch circuit of the present invention has the same function as the conventional switch circuit. However, as compared with the conventional switch circuit, the switch circuit of the present invention has a smaller circuit area, and thus the cost is lowered.

Though the present invention has been disclosed above by the embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A switch circuit, comprising:
a control unit, having a first end, a second end, and a third end, wherein the first end of the control unit receives a first voltage, and a voltage difference between the first end and the third end of the control unit is steady; and
a voltage level adjusting circuit, having a switch, wherein whether the switch can be turned on or off depends on a voltage on the second end of the control unit, so as to drive a load and furthermore the voltage level adjusting circuit is used for adjusting a bias of the load on driving, the voltage of the switch is varied following an ON/OFF of the switch, and the third end of the control unit is varied following the voltage of the switch.

2. The switch circuit as claimed in claim 1, wherein the voltage level adjusting circuit further comprises at least one energy storage element, for adjusting the bias of the load on driving by storing energy.

3. The switch circuit as claimed in claim 1, wherein the control unit is a pulse width modulation (PWM) circuit.

4. The switch circuit as claimed in claim 1, wherein the voltage level adjusting circuit is a buck circuit.

5. The switch circuit as claimed in claim 1, further comprising a power source, wherein the first voltage is generated according to a voltage level of the power source.

6. The switch circuit as claimed in claim 1, further comprising a voltage regulator circuit, for stabilizing a voltage level of the first voltage.

7. The switch circuit as claimed in claim 1, further comprising a feedback circuit, for detecting varying of a conduction current when the load is driven, wherein the control unit controls a magnitude of the conduction current of the load according to the change of the conduction current of the load.

8. The switch circuit as claimed in claim 4, wherein the buck circuit comprises:
the switch, is an NMOS transistor having a drain coupled to a second voltage, a source coupled to the third end of the control unit, and a gate coupled to the second end of the control unit;
an inductor, having a first end coupled to the third end of the control unit, and a second end; and
a capacitor, having a first end and coupled to the second end of the inductor a second end coupled to a lowest voltage level of the switch circuit, wherein the load is coupled between the first end and the second end of the capacitor.

9. The switch circuit as claimed in claim 8, wherein the buck circuit further comprises:
a diode, coupled between the first end of the inductor and the lowest voltage level of the switch circuit for forming a loop comprising of the diode, the inductor, and the capacitor.

10. The switch circuit as claimed in claim 7, wherein the feedback circuit comprises a resistor coupled between the load and the lowest voltage level of the switch circuit, the control unit detects the varying of the conduction current of the load by the voltage on the two ends of the resistor.

11. The switch circuit as claimed in claim 10, wherein the control unit has a positive feedback input end and a negative feedback input end, and the control unit comprises:
an adder, having a first input end coupled to the negative feedback input end, and a second input end receiving a reference voltage;
a feedback comparator, having a positive input end coupled to the positive feedback input end of the control unit, and a negative input end coupled to an output end of the adder;
an output comparator, having a positive input end receiving an oscillation signal, and an output end serving as the second end of the control unit;
a compensation element, coupled between a negative input end of the output comparator and the third end of the control unit, for compensating the voltage on the negative input end of the output comparator; and
a changeover switch, disposed between an output end of the feedback comparator and the negative input end of the output comparator, wherein whether the changeover switch can be turned on or off depends on the voltage on the third end of the control unit.

12. The switch circuit as claimed in claim 10, wherein the control unit has a positive feedback input end and a negative feedback input end, and the PWM control unit comprises:
a subtractor, having a first input end coupled to the positive feedback input end, and a second input end receiving the negative feedback end;
a feedback comparator having a positive input end coupled to a reference voltage, and a negative input end coupled to an output end of the subtractor;
an output comparator, having a negative input end receiving an oscillation signal, and an output end serving as the second end of the control unit;
a compensation element, coupled between a positive input end of the output comparator and the third end of the control unit, for compensating the voltage on the negative input end of the output comparator; and
a changeover switch, disposed between an output end of the feedback comparator and the positive input end of the output comparator, wherein whether the changeover switch can be turned on or off depends on the voltage on the third end of the control unit.

13. The switch circuit as claimed in claim 8, wherein the transistor is an NMOS transistor.

14. The switch circuit as claimed in claim 11, wherein if the changeover switch is an NMOS transistor, the control unit further comprises an inverter coupled between the changeover switch and the output end of the output comparator, for inverting a control signal of the changeover switch.

15. The switch circuit as claimed in claim 6, further comprising:
a voltage regulator resistor, coupled between the power source and the first end of the control unit;
a zener diode, coupled between the first end and the third end of the control unit; and
a capacitor, coupled between the first end and the third end of the control unit.

16. The switch circuit as claimed in claim 1, wherein the load is an LED.

17. The switch circuit as claimed in claim 1, wherein the voltage level adjusting circuit is a boost circuit.

18. The switch circuit as claimed in claim 17, wherein the boost circuit comprises:
the switch, is an NMOS transistor having a gate end coupled to the second end of the control unit, and a source end coupled to the lowest voltage level of the switch circuit;
an inductor, having a first end coupled to a second voltage, and a second end coupled to a drain end of the NMOS transistor;
a capacitor, having a first end and a second end, wherein the second end coupled to the lowest voltage level of the switch circuit; and
a diode, having an anode end coupled to the drain end of the NMOS transistor and a cathode end coupled to the first end of the capacitor.

19. The switch circuit as claimed in claim 1, wherein the switch has a source, the voltage on the source of the switch is varied following the ON/OFF of the switch, and the voltage on the third end of the control unit is varied following the voltage on the source of the switch.
